(19) United States
(12) Patent Application Publication
(10) Pub. No.: US 2022/0406168 A1
(43) Pub. Date: Dec. 22, 2022

(54) AN INFORMATION DISTRUBITION SYSTEM FOR A LOCAL AREA

(71) Applicant: BRINJA AB, Göteoborg (SE)

(72) Inventors: Xavier LEON, Nödinge (SE); Axel SJÖGREN HOLTZ, Göteborg (SE); Robert REHAMMAR, Romelanda (SE); Mats ANDERSSON, Göteborg (SE)

(21) Appl. No.: 17/623,210

(22) PCT Filed: Jun. 25, 2020
(86) PCT No.: PCT/EP2020/067891

§ 371 Date: Dec. 27, 2021

(30) Foreign Application Priority Data
Jun. 28, 2019 (SE) 1930230-6

(51) Int. Cl. G08B 27/00; G08B 3/10

(52) U.S. Cl. CPC G08B 27/00; G08B 3/10

(57) ABSTRACT

A system for communicating information to a person in a local area. The system includes a device arranged noticeable by the person and a power source arranged to power the device. The system further includes a relay arranged in-between the power source and the device, and a control unit arranged to generate a control signal in response to an event. The relay is arranged to connect the device to the power source in absence of the control signal, and to temporarily disconnect the device from the power source in response to the control signal generated by the control unit, thereby communicating the information to the person.

### CROSS-REFERENCE TO RELATED APPLICATIONS

This application is the U.S. national phase of International Application No. PCT/EP2020/067891 filed Jun. 25, 2020 which designated the U.S. and claims priority to Swedish Patent Application No. 1930230-6 filed Jun. 28, 2019, the entire contents of each of which are hereby incorporated by reference.

### BACKGROUND OF THE INVENTION

### Field of the Invention

The present disclosure relates to systems, devices and methods for conveying information such as notifications and emergency signals to a group of people in a local area by the means of, i.a., light devices.

### Description of the Related Art

Evacuation of people from a local area is, in general, a difficult problem. It is often necessary to perform the evacuation rapidly, but at the same time it must be ensured that no-one is left behind and unaware that evacuation has been initiated.

Some sites lack permanent alarm systems. At such locations, evacuation is often manually performed by a site manager or by dedicated evacuation personnel, which notifies staff in the event of an emergency and makes sure that everybody leaves the area and that nobody is left behind unaware of the emergency.

Large construction sites comprising buildings with many floors are difficult to overview. If all staff on such a construction site needs to be evacuated, large manual operations have to be carried out to verify that no one is still left and that all personnel has been made aware of the evacuation need. Evacuation in such scenarios often take time and it is hard to make sure that everybody receives the evacuation notification and are able to leave the local area without delay.

Also, some local areas, like constructions sites or factories where heavy machinery is in use, are noisy. It may be difficult to hear an alarm signal even if such a system is available.

There is a need for improved alarm systems for use in local areas, and in particular for use in local areas lacking a permanent alarm generation system.

### SUMMARY OF THE INVENTION

It is an object of the present disclosure to provide solutions to, or at least alleviate, some of the above-mentioned problems associated with emergency signaling and evacuation in local areas. This object is obtained by a system for communicating information to a person in a local area.

The system comprises a power source arranged to power a device arranged noticeable by the person. The device may be a light source arranged noticeable by the person in the local area, but it may also be other types of noticeable devices, such as audible devices like loud machinery or devices which can be felt by the person as long as they are active, such as machinery generating vibration or fans which drive noticeable air flows. The system further comprises a relay arranged in-between the power source and the device to temporarily disconnect the device from the power source based on a control signal, thereby communicating information to the person. The system also comprises a control unit arranged to generate the control signal in response to an event. In other words, the relay is arranged to connect the device to the power source in absence of the control signal, and to temporarily disconnect the device from the power source in response to the control signal generated by the control unit, thereby communicating the information to the person.

By using a device arranged noticeable, such as a light source, a person is able to see, feel or hear that there is an alarm signal, since the device arranged noticeable is temporarily disconnected by the system, i.e., turned off. Other noticeable devices may include, e.g., fans and certain types of machinery, such as machinery generating noticeable noise and vibration.

The system does not rely on a permanent information dissemination system installation, but instead makes use of a power source, which can be a temporary power grid at a construction site or the like. Such temporary power sources are often available even if no permanent infrastructure for communication or warning has been installed. In fact, one of the first systems in place at a construction site is often a temporary power grid or cable to power tools and construction machinery.

The person notices the event due to the temporarily disconnected device. When the relay acts to disconnect the device from the power source, the person notices the event and is thereby made aware that something is going on. Thus, by temporarily disconnecting the device from the power source based on a control signal, information is communicated to the person. The device is initially in a semi-permanent on-state before it is temporarily turned off. It is thus appreciated that the warning systems disclosed herein are inherently different from known warning systems which activate a device such as a light source in response to an event, since the present systems instead inactivate a device which is normally active, i.e., connected to the power source.

If the device is a light device, the temporarily disconnecting the light device means that the light device is turned off from an on-state providing sustained light.

It is an advantage that the device is only temporarily turned off by the relay, since the device may be necessary for the evacuation. For instance, turning off lights entirely may complicate an evacuation.

According to aspects, the information is an alarm signal and the event is an emergency event associated with the local area. Although the disclosed system can be used to disseminate various other types of messages, it is particularly suitable for use with emergency evacuation signals and other warning signals.

According to aspects, the control unit is arranged to sequentially connect and disconnect the device to and from the power source according to a pre-determined time sequence in dependence of a type of the event, thereby communicating the information to the person. The sequential connection and disconnection may be done after initially disconnecting the device from the power source in response to the control signal. Blinking lights or some other device turning on and off according to some time sequence is noticeable in many local areas, and therefore an effective warning system even if noise levels are high. The blinking pattern can also be adjusted to communicate various different messages, for instance, a rapid blinking can be an alarm signal prompting immediate evacuation, while a slow blinking can be a signal prompting personnel to seek information at some gathering point. Thus, a versatile information dissemination system is provided, which is an advantage.

According to aspects, the system comprises a mobile device arranged to remotely trigger generation of the control signal. The mobile device may, e.g., be a cellular device connected to the system via a cellular system, a local area network (LAN) device connected to the system via a local area network, or some other radio transceiver such as a walkie-talkie or the like which can be directly connected to the control unit via wireless link.

According to aspects, the control unit comprises a siren, buzzer, or other sound generating device. Thus, the temporary disconnecting of the device can be complemented by some more traditional warning system, such as the siren. This way an alarm signal becomes even more noticeable by personnel in the local area. The siren can be driven by the power source, since the power source can be connected to the siren without being affected by the relay operation.

According to aspects, the control unit and the relay are integrated into a single unit. By integrating control unit and relay, a single unit is provided which can be made more resilient to mechanical impact and damage from, e.g., water or the like, which is an advantage. Also, a single unit is more easily installed and managed.

According to aspects, the system also comprises one or more sensor devices connected to the control unit and arranged to detect occurrence of the event. Such sensors may, e.g., comprise gas leak sensors or fire detectors. This way a more complete warning system can be obtained based on a power grid such as a temporary power grid at a construction site.

There are furthermore disclosed herein control units, remote servers and computer programs associated with the same advantages as discussed above in connection to the different systems.

According to aspects, the power source is a remote power source and the control unit comprises a power terminal arranged to connect the control unit to the remote power source via a first electrical wire. According to further aspects, the device is a remote light device and wherein the control unit comprises a device terminal arranged to connect the control unit to the remote light device via a second electrical wire. Thereby, the device terminal is not arranged to directly mate with the light device. A technical effect of having a device terminal, rather than having a light device directly mounted to the control unit, is that the control unit is separated from the remote light device. This leads to a huge increase in flexibility and allows for many more applications. One particular advantage is that the control unit can be arranged between an existing remote power source and an existing remote light device at, e.g., a construction site. This allows for a cost-effective system that is easy to install. The device terminal or power terminal may comprise any connector, jack, or interface suitable for connecting an electrical wire. A non-limiting example of a terminal is a screw terminal. The terminals and electrical wires may or may not have genders. The connection between the terminal and the wire may be removable, which may or may not require tools, or it may be permanent. The terminals may be arranged to receive an adapter between the terminal and the electrical wire.

There is also disclosed herein a control unit for a construction site warning system configured to communicate information to a person in a local area. The control unit comprises a power terminal arranged to connect the control unit to a remote power source via a first electrical wire. The control unit further comprises a device terminal arranged to connect the control unit to a remote light device via a second electrical wire, where the remote light device is arranged noticeable by the person. The control unit is arranged to control an electrical connection between the power terminal and the device terminal in response to an event, thereby communicating information to the person.

According to aspects, the control unit comprises an overcurrent protection device arranged to provide an overcurrent protection of an electrical circuit comprising the power terminal and the device terminal. The overcurrent protection device can, e.g., prevent the remote light device from breaking or overheating.

According to aspects, the control unit comprises a ground fault circuit interrupter, GFCI, arranged between the power terminal and the device terminal to provide ground fault protection for the device terminal. The GFCI unit can prevent electrical current flowing through a person due to an electrical fault.

According to aspects, the control unit comprises a light emitting diode, LED, driver unit arranged between the power terminal and the device terminal to drive one or more LED devices connected to the device terminal via the second electrical wire. This may prevent thermal runaway of an LED connected to the device terminal.

According to aspects, the control unit comprises an electrical power converter arranged between the power terminal and the device terminal. An example of a power converter is a transformer, which transforms alternating current and voltage levels to different values. Another example is a rectifier, which transforms alternating current to direct current. In general, a power converter is an electro-mechanical or electrical device that converts electrical energy. Having an electrical power converter be an integral part of the control unit allows for a system that is easy to install.

According to aspects, the control unit comprises an electrostatic discharge protection circuit arranged between the power terminal and the device terminal. This way, the control unit can be protected from discharges onto the remote light device or the second electrical wire.

According to aspects, the control unit comprises one or more sensor devices arranged to detect occurrence of the event. Such sensors may, e.g., comprise gas leak sensors or fire detectors. This way a more complete warning system can be obtained based on a power grid such as a temporary power grid at a construction site.

According to aspects, the remote light device is associated with a controllable light parameter, and the control unit is arranged to transmit a control command signal via the device terminal to control the controllable light parameter. According to further aspects, the light parameter comprises any of: color, intensity, blinking rate, and spatial distribution of illumination. The control unit may operate to control a color parameter of the remote light device in dependence of a type of event, thereby communicating information to the person.

According to aspects, the local area comprises a plurality of sections, and the control unit is arranged to configure the light parameter in dependence of a section or sections in which the event has occurred.

According to aspects, the local area comprises a plurality of sections with respective remote light devices, and the device terminal comprises a plurality of branches. Each branch is connected to a remote light device in a respective section in the plurality of sections. The control unit is arranged to control the light parameter and/or the electrical connection of a remote light device in a certain section, thereby communication information to that certain section. The control unit can thereby send control signals along each respective branch and/or control the electrical connection of each branch.

According to aspects, the local area comprises a plurality of sections with respective remote light devices. The control unit is then arranged to control the light parameter of a remote light device in a certain section by sending a control signal addressed to that certain section, thereby communicating information to that certain section. This way, the remote light devices can be connected in a daisy chain, wherein each remote light device receives the control signal, but only the particular remote light device which the control signal is addressed to listens to the command. Naturally, it is possible to combine the two ways, i.e. to arrange some remote light devices in one or more daisy chains and arrange other remote light devices to be connected to individual branches.

According to aspects, the control unit is arranged to control the light parameter in the certain section in dependence of a distance between the certain section and the section or sections in which the event has occurred. For instance, if a room in a building is on fire, lights may blink in a red color at a faster pace the closer the particular light is to the room on fire. This way, the proximity to danger is communicated to the person in the local area.

According to aspects, the local area comprises a plurality of sections, and the control unit is arranged to communicate information comprising restriction of access to at least one section in the plurality of sections by controlling the light parameter.

The methods disclosed herein are associated with the same advantages as discussed above in connection to the different measurement devices.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where:

FIG. 1 schematically illustrates a control unit for an alarm system;

FIGS. 2A-2D show example control units;

FIG. 3 is a flow chart illustrating methods;

FIG. 4 schematically illustrates an example control unit;

FIG. 5 shows a computer program product;

FIG. 6 schematically illustrates an alarm system;

FIG. 7 shows an example alarm system;

FIG. 8 is a flow chart illustrating methods;

FIGS. 9A-9C show example remote light devices;

FIGS. 10A and 10B show example control units; and

FIGS. 11A-11C show example control units.

### DESCRIPTION OF THE PREFERRED EMBODIMENTS

Aspects of the present disclosure will now be described more fully with reference to the accompanying drawings. The different devices and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

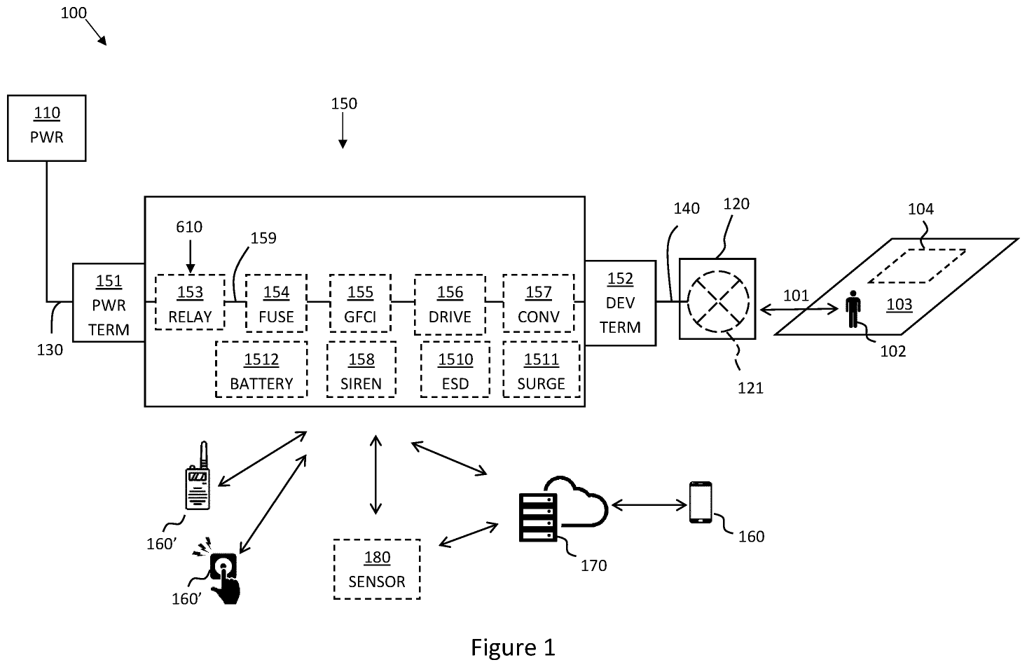

FIG. 1 shows a system 100 for communicating information 101 to a person 102 in a local area 103. The local area may, e.g., be a construction site or some other local area where no permanent evacuation alarm system has been installed. The communicated information 101 may be an alarm signal indicating occurrence of an emergency event associated with the local area 103. However, the system can also be used for more general information dissemination.

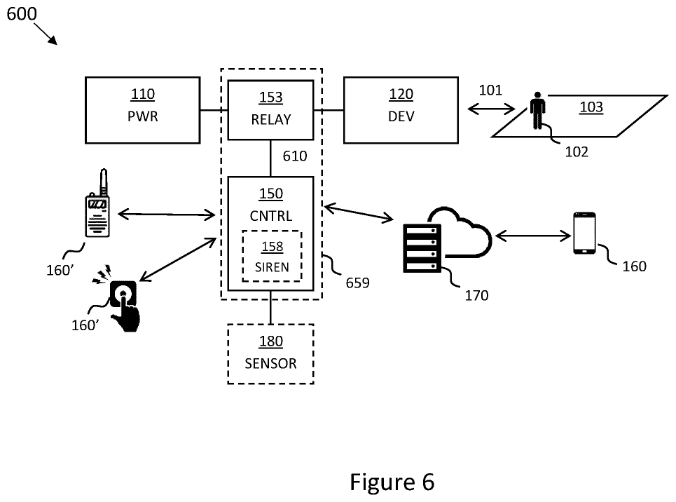

Some example embodiments of the system, as well as related methods, shown in FIG. 1 will be discussed below in connection to FIGS. 6-8.

The disclosed system is particularly suitable for use at construction sites and the like which are often equipped with temporary power infrastructures (i.e. temporary power sources), such as temporary power grid systems or power cables, but which rarely comprise permanent evacuation systems.

The disclosed system is suitable for communicating information 101 to a person 102 in a local area 103. The system comprises a power source 110 arranged to power a device 120 arranged noticeable by the person 102. The device may be a light source 121 arranged noticeable by the person 102 in the local area 103, but it may also be other types of noticeable devices , such as audible devices like loud machinery or devices which can be felt by the person as long as they are active, such as machinery generating vibration or fans which drive noticeable air flows. The system further comprises a relay 153 arranged in-between the power source 110 and the device 120 to temporarily disconnect the device from the power source based on a control signal, thereby communicating information to the person 102. The system also comprises a control unit 150 arranged to generate the control signal in response to an event. In other words, the relay 153 is arranged to connect the device 120 to the power source 110 in absence of the control signal, and to temporarily disconnect the device from the power source in response to the control signal generated by the control unit 150, thereby communicating the information to the person 102.

The control unit 150 may comprise a power terminal 151 arranged to interface with the power source 110 and a device terminal 152 arranged to interface with the device 120. The device terminal 152 may be a light terminal arranged to interface with a remote light source 121, as will be discussed in more detail below.

The person notices the event due to the temporarily disconnected device. When the relay 153 acts to disconnect the device 120 from the power source 110, the person 102 notices the event and is thereby made aware that something is going on. Thus, by temporarily disconnecting the device from the power source based on a control signal, information is communicated to the person 102. The device is initially in a semi-permanent on-state before it is temporarily turned off. It thus appreciated that the warning systems disclosed herein are inherently different from known warning systems which activate a device such as a light source in response to an event, since the present systems instead inactivate a device which is normally active, i.e., connected to the power source.

If the device is a light device, the temporarily disconnecting the light device 121 means that the light device is turned off from an on-state providing sustained light.

It is an advantage that the device is only temporarily turned off by the relay, since the device may be necessary for the evacuation. For instance, turning off lights entirely may complicate an evacuation.

The power source 110 may be a remote power source. In that case, the control unit comprises a power terminal 151 arranged to connect the control unit 150 to the remote power source 110 via a first electrical wire 130. According to aspects, the first electrical wire is a wire capable of 16 A. An example length of the first electrical wire could be 5 m. Furthermore, the device 120 may be a remote light device. The control unit comprises a device terminal 152 arranged to connect the control unit 150 to the remote light device 121 or to some other device 120 via a second electrical wire 140. An example length of the second electrical wire could be 5 m. The remote power source 110 is arranged to power the remote light device 121. The remote power source and remote light device are remote in the sense that they are physically separated from each other.

Herein, “noticeable by the person” is to be interpreted broadly. For instance, a remote light device such as a light bulb or diode may be arranged in a room and the person may be in the same room, in which case the person may directly notice the remote light device. However, the person could also be in a different room from the remote light device, but the remote light device is still considered noticeable by the person, since the person may enter the room with the remote light device. Another example of a remote light device arranged noticeable could be an area comprising a remote light device 121 with a narrow beam which only illuminates a local spot on the floor in the local area. In this case, the remote light device is considered noticeable by the person in the local area even if the person is not in line of sight of the illuminated spot or light source. Thus, “noticeable by the person” is, according to some aspects, to be interpreted as noticeable by a person anywhere in the local area, including places without line of sight to the remote light device.

The remote light device 121 is a source of light which can be seen by personnel occupying the local area 103, at least when the personnel is located in certain sections of the local area. The remote light device may comprise a single unit or it may comprise a plurality of distributed units. The remote light device may be the only form of light illumination in the local area 103, where it can be the work light for the personnel occupying the local area. In that case, the remote light device may provide enough illumination for a safe and productive work environment. It may also be a complementary source of light. The remote light device may, e.g., comprise light emitting diode (LED) light bulbs, LED strips and colored LED strips, such as red-green-blue (RGB) controllable diodes. In an example embodiment, the remote light device 121 provides the same or more illumination as a 40-W incandescent light bulb.

According to aspects, the control unit 150 is arranged to control the remote light device 121 in response to an event. The control unit comprises a power terminal 151 arranged to connect the control unit 150 to a remote power source 110 via a first electrical wire 130. The control unit further comprises a device terminal 152 arranged to connect the control unit 150 to a remote light device 121 via a second electrical wire 140. An electrical wire is flexible strand or rod comprising an electrically conducting material, e.g. copper. Herein, electrical wire is to be interpreted broadly. For example, a plurality of wires, one or more cables, or the like may constitute the electrical wire. The remote power source and remote light device are physically remote from the control unit. As mentioned, an example length of an electrical wire could be 5 m. An electrical wire herein is not to be interpreted as traces on a printed circuit board.

The device terminal 152 is arranged to be connected to a remote light device 121 via a second electrical wire 140. Thereby, the device terminal is not arranged to directly mate with the light device. A technical effect of having a device terminal, rather than having a light device directly mounted to the control unit, is that the control unit is separated from the remote light device. This leads to a huge increase in flexibility and allows for many more applications, which are discussed throughout the present disclosure. One particular advantage is that the control unit 150 can be arranged between an existing remote power source and an existing remote light device at, e.g., a construction site. This allows for a cost-effective system 100 that is easy to install. The device terminal or power terminal may comprise any connector, jack, or interface suitable for connecting an electrical wire. A non-limiting example of a terminal is a screw terminal. The terminals and electrical wires may or may not have genders. The connection between the terminal and the wire may be removable, which may or may not require tools, or it may be permanent. The terminals may be arranged to receive an adapter between the terminal and the electrical wire.

Regarding the controlling of the remote light device 121, the control unit 150 controls the electrical connection 159 between the power terminal and the device terminal in response to an event, thereby communicating information 101 to the person 102. In other words, the control unit can control the remote light device 121 to be turned off and on. Thus, when the electrical connection is controlled, the person 102 notices the event and is thereby made aware that something is going on, i.e. information is communicated to the person 102.

The control unit may be operable to sequentially connect and disconnect the device 120 to and from the remote power source 110 according to a pre-determined time sequence in dependence of a type of the event, thereby communicating the information 101 to the person 102. The sequential connection and disconnection may be done after initially disconnecting the device from the power source in response to the control signal. The pre-determined time sequence may be just normal blinking at some rate. However, more advanced signals may be communicated by varying the blinking pattern. For instance, rapid blinging may indicate some type of event, like an emergency requiring immediate evacuation, while more slow blinking may indicate an emergency requiring caution but not immediate evacuation. The sequentially connecting and disconnecting of the device may be achieved by having the control unit comprising a relay. The control unit may be arranged to have the relay temporarily disconnect the electrical connection 159 between the power terminal and the device terminal in response to an event. As mentioned, it is an advantage that the device is only temporarily turned off by the relay since the illumination from the remote light device 121 may be necessary for the evacuation, since, e.g., turning off lights entirely may complicate an evacuation.

To summarize, there is, herein, disclosed a control unit 150 for a construction site warning system configured to communicate information 101 to a person 102 in a local area 103. The control unit comprises a power terminal 151 arranged to connect the control unit 150 to a remote power source 110 via a first electrical wire 130. The control unit further comprises a device terminal 152 arranged to connect the control unit 150 to a remote light device 121 via a second electrical wire 140. The remote light device is arranged noticeable by the person 102. The control unit 150 is arranged to control an electrical connection 159 between the power terminal and the device terminal in response to an event, thereby communicating information 101 to the person 102.

The control unit 150 may comprise an overcurrent protection device 154 arranged to provide an overcurrent protection of an electrical circuit comprising the power terminal and the device terminal. The overcurrent protection device can be an electrical fuse, such as melting fuse or a resettable fuse, or it can be a circuit breaker or the like. The overcurrent protection device can, e.g., prevent the remote light device 121 from breaking or overheating.

The control unit 150 may comprise a ground fault circuit interrupter (GFCI), 155 arranged between the power terminal 151 and the device terminal 152 to provide ground fault protection for the device terminal. Other terms for GFCI are residual-current device (RCD), ground fault interrupter (GFI), appliance leakage current interrupter (ALCI), or leakage current detection interrupter (LCDI). A GFCI is arranged to quickly break the electrical connection of a circuit when the electric current from the supply and return conductors differ. The GFCI unit can prevent electrical current flowing through a person due to an electrical fault.

According to aspects, the remote light device 121 comprises one or more LEDs. Thus, the control unit 150 may comprise an LED driver unit 156 arranged between the power terminal 151 and the device terminal 152 to drive one or more LED devices connected to the device terminal via the second electrical wire. LED drivers commonly work by providing a constant current to the LED, which prevents thermal runaway.

The control unit 150 may comprise an electrical power converter 157 arranged between the power terminal 151 and the device terminal 152. An example of a power converter is a transformer, which transforms alternating current and voltage levels to different values. Another example is a rectifier, which transforms alternating current to direct current. In general, a power converter is an electro-mechanical or electrical device that converts electrical energy. Having an electrical power converter be an integral part of the control unit allows for a system 100 that is easy to install.

The control unit 150 may comprise an electrostatic discharge, ESD, protection circuit 1510 arranged between the power terminal 151 and the device terminal 152. This way, the control unit can be protected from discharges onto the remote light device or the second electrical wire 140.

The control unit 150 may comprise a surge protection circuit 1511 arranged between the power terminal 151 and the device terminal 152. This way, the control unit can be protected from voltage spikes from the remote power source 110.

The control unit 150 may comprise a backup battery 1512 arranged between the power terminal 151 and the device terminal 152. This way, the control unit can be operational in case the connection to the remote power device 110 is disconnected. The backup battery 1512 may comprise a management system arranged to manage charge levels and to protect the battery from over- or undervoltage conditions.

The remote light device 121 may be associated with a controllable light parameter, such as color, intensity, blinking rate, and spatial distribution of illumination. Thus, the control unit 150 may further be arranged to transmit a control command signal via the device terminal to control the controllable light parameter in response to the event, thereby communicating the information to the person 102.

The control unit may operate to control a color parameter of the remote light device 121 in dependence of a type of event, thereby communicating information to the person 102. Herein, the color parameter comprises any of hue, saturation, and brightness of the emitted light. In other words, controlling the color parameter is a change in color noticeable by the person 102. One example is to control the wavelength of the emitted light within the visible spectrum. Examples of controls can be switching from a nominal white colored light to red light to indicate some type of event, like an emergency requiring immediate evacuation, and switching from a nominal white colored light to yellow light to indicate an emergency requiring caution but not immediate evacuation. There may be a range of colors indicating the severity of a possible evacuation, ranging from, e.g., leaving immediately to leaving after all equipment is turned off. In an example embodiment, the remote light device comprises an RGB diode with an internal color changing unit. The color changing unit changes the combination of red, green, and blue of the diode and it accepts a digital control signal. Thus, the control unit 150 is arranged to transmit a digital signal to the remote light device 121 to control the remote light device in response to an event. In another example embodiment, the remote light device comprises differently colored light bulbs and the control unit 150 controls the remote light device by turning on or more of differently colored light bulbs on and off, and/or by changing the intensities of one or more of the differently colored light bulbs.

It is noted that it is possible to use multiple control units 150. For example, in a multi-store building under construction, there may be one control unit per floor or there may be a single control unit for the whole building.

The control unit 150 may control the intensity, i.e. the luminous flux, of the remote light device 121 to communicate information 101. For example, the control unit may operate to sequentially increase and decrease the intensity of the remote light device to convey information. Furthermore, the control unit may control the spatial distribution of illumination of the remote light device to communicate information. For example, the control unit may operate the remote light device to emit less light in a certain direction, and/or, if the local area is divided into sections, a certain section 104.

The control unit 150 may be arranged to control a combination of light parameters in response to the event, thereby communicating the information 101 to the person 102. This can be in combination with controlling the electrical connection 159 between the power terminal 151 and the device terminal 152. The combination can be simultaneous, as in blinking and changing color at the same time, and/or in sequence, as in first blinking a few times than changing color. For example, in the event of a fire or toxic gas leak, the control unit may first blink all light sources in the local area 103 three times and thereafter change the color from a nominal white light to red. In this example scenario, the whole local area is illuminated in red light in response to the event. Another option could be to change the color and continuously blinking the light in response to an event. Advantageously, controlling a combination of one or more light parameters and the color parameter can be used to provide a form of redundancy when communicating information to the person, i.e. there are more than one way of communication the same thing. Redundancy is specifically important in evacuation procedures where human lives may be in grave danger, especially since some persons may suffer from color blindness or have impaired vision, perhaps as a result of an accident.

The information 101 may also comprise a plurality of different messages. The control unit 150 may then be arranged to control a plurality of different light parameters, where each light parameter in the plurality is associated with a respective message out of the plurality of messages. An example can be to convey an evacuation message and a message that the primary evacuation route has been compromised at the same time, by switching from a nominal white light to a simultaneously blinking red and blue light, where the red light is associated with the evacuation message and the blue light is associated with the compromised evacuation route. Rather than simultaneously blinking two colors, it is also possible to alternate between two colors.

The local area 103 may comprise a plurality of sections 104. In that case, the control unit can be arranged to configure the light parameter in dependence of a section or sections in which the event has occurred. A section could, e.g., be a room, a floor, or a part of a floor in a building under construction. A section could also be some arbitrary surface in a room. An example use case for such features is when the dust levels are too high in a particular room in a building. Then the control unit could change the color of the light in the whole building, thereby communicating that the particular room has too high dust levels, that the particular room should be evacuated, that the particular room should not be entered, and that the rest of the building is safe and does not need to be evacuated.

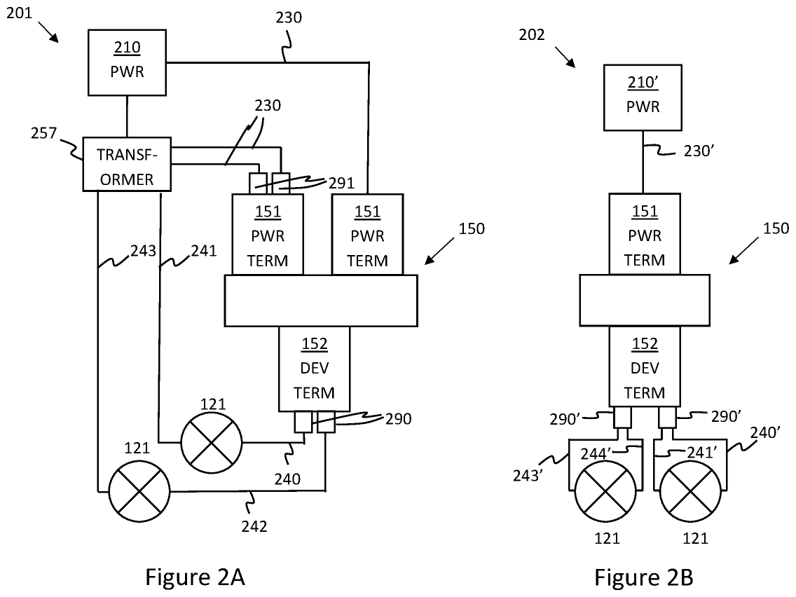

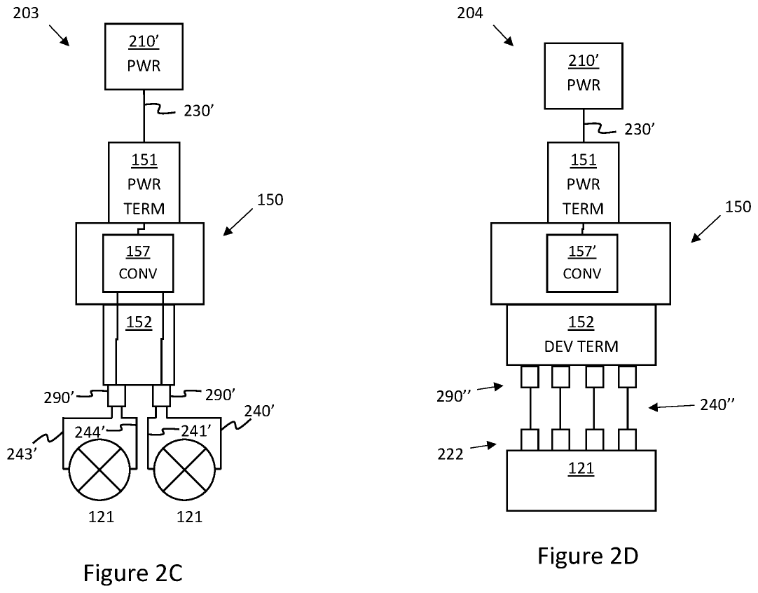

The local area 103 may comprise a plurality of sections 104 with respective remote light devices 121. In that case, the control unit 150 may be arranged to control the light parameter and/or the electrical connection 159 of a remote light device in a certain section, thereby communication information 101 to that certain section. One way of achieving this is by having the device terminal 152 comprise a plurality of branches (see, e.g., 290 in FIG. 2A), wherein each branch is connected to a remote light device 121 in a respective section in the plurality of sections. The control unit can thereby send control signals along each respective branch and/or control the electrical connection of each branch. An alternative way is to arrange the control unit 150 to control the light parameter of a remote light device in a certain section by sending a control signal addressed to that certain section, thereby communicating information 101 to that certain section. This way, the remote light devices can be connected in a daisy chain, wherein each remote light device receives the control signal, but only the particular remote light device which the control signal is addressed to listens to the command. Naturally, it is possible to combine the two ways, i.e. to arrange some remote light devices in one or more daisy chains and arrange other remote light devices to be connected to individual branches.

An example use case for the features in the above paragraph is when dust levels are too high in a particular room in a building. Then the control unit could change the color of the light the particular room, thereby communicating that the particular room has too high dust levels and should be evacuated. The lights in the rest of the building remains unchanged, indicating the rest of the building is safe and does not need to be evacuated. Another example is in a construction site with two separate buildings. In the event of a fire in the first building, the lights may be changed to a red color in the first building to indicate that immediate evacuation is required, and be changed to a yellow color in the second building to indicate that a slower pace evacuation is sufficient. Thus, the control unit may be arranged to communicate information 101 comprising restriction of access to at least one section in the plurality of sections by controlling the light parameter. Another use case could be to highlight the exit directions and/or paths, in, e.g., a green or white color, while the rest of the local area is illuminated by red blinking light in response to an event. Another example can be to have certain critical areas permanently lit, i.e. areas that should never be dark, such as staircases.

If the local area 103 comprises a plurality of sections 104 with respective remote light devices 121, the control unit may be arranged to control the light parameter in a certain section in dependence of a distance between the certain section and the section or sections in which the event has occurred. For instance, if a room in a building is on fire, lights may blink in a red color at a faster pace the closer the particular light is to the room on fire. This way, the proximity to danger is communicated to the person in the local area.

According to some aspects, the control unit 150 may comprise wireless receivers arranged to receive a remote trigger from one or more mobile devices 160, 160′. The mobile device may trigger the control unit to control the electrical connection 159 between the power terminal and the device terminal in response to an event, and/or to transmit a control command signal via the device terminal to control the controllable light parameter. The mobile device may be a cellular device connected to the control unit 150 via a remote server 170 or via some network. The mobile device 160′ may also be a radio device such as an intercom device configured to directly communicate with the control unit 150. The mobile device 160′ may also comprise a wireless local area network (LAN) transceiver, such as a Wi-Fi transceiver.

According to some aspects, the mobile device may be a wireless transceiver comprised in an alarm button or the like.

It is noted that a siren 158 or other audio-based alarm system could be connected to the control unit. The connection could be wired or wireless, or the siren could be an integral part of the control unit. This provides a complementary means of communicating information to the person 102 the in local area, which acts to reinforce the information communicated to the person by means of the control unit 150 and remote light device 121.

According to aspects, the control unit 150 comprises one or more sensor devices 180 arranged to detect occurrence of the event. The sensor devices may be connected to the control unit with a wired and/or wireless connection, and/or be integrated in the control unit. Alternatively, or in combination of, the sensor devices may be connected to the cloud, wherein communication from the sensor devices is relayed to the control unit 150 via the cloud. These optional sensor devices may comprise capability for sensing any of the parameters: air temperature, air humidity, air dust levels, dust composition, ambient noise, carbon monoxide gas, carbon dioxide gas, fumes from fire, any gas, vibrations or the like. Sensing dust composition may comprise sensing particle size and type of material, which can be useful since, e.g., quarts is more dangerous than saw dust.

As mentioned, the relay 153, the over current protection device 154, the GFCI 155, LED driver 156, the electrical power converter 157, the siren 158, the surge protection circuit 1511, the backup battery 1512, and the sensor device 180 may be integral parts of the control unit. It is noted that, however, that the system 100 may comprise any of those devices/components wherein they are arranged separate from the control unit. For example, the power converter 157 may be arranged between the power terminal 151 and the power source 110. Furthermore, the system 100 may comprise said mobile devices 160, 160′.

FIGS. 2A-2D show example warning systems 201, 202, 203 and 204 according to the discussions above. In FIG. 2B, the control unit 150 is connected to the remote light device 121 as an in-line cord control, whereas, in FIG. 2A, the control unit 150 is connected to the remote light device via a voltage transformer 257. In FIG. 2A, two supply wires 240, 242 are connected from the device terminal 152 to respective remote light devices 121 via respective branches 290. Two return wires 241, 243 connect the two remote light devices to the voltage transformer. In FIG. 2B, two supply wires 240′, 242′ are connected from the device terminal 152 to respective remote light devices 121 via respective branches 290′. Two return wires 241′, 243′ connect the two remote light devices back to the respective branches 290′. In FIG. 2A, the control unit 150 is powered via the voltage transformer 257, which in turn is connected to the remote power source 210, and directly from the power source 210, whereas in FIG. 2B, the control unit is directly powered by the remote power source 210′. Furthermore, in FIG. 2A, a respective electrical loop for the two remote light devices 121 is connected via the transformer 257 through a respective power terminal branch 291 on the power terminal 151.

FIG. 2C is similar to FIG. 2B, except that the two remote light devices 121 are connected via a power converter in the control unit. FIG. 2D shows an example system 204 where the remote light device 121 comprises a plurality of light device branches 222, connected via respective wires 240″, which in turn connected to respective branches 290″ on the device terminal 152, which are connected to the power converter 157′.

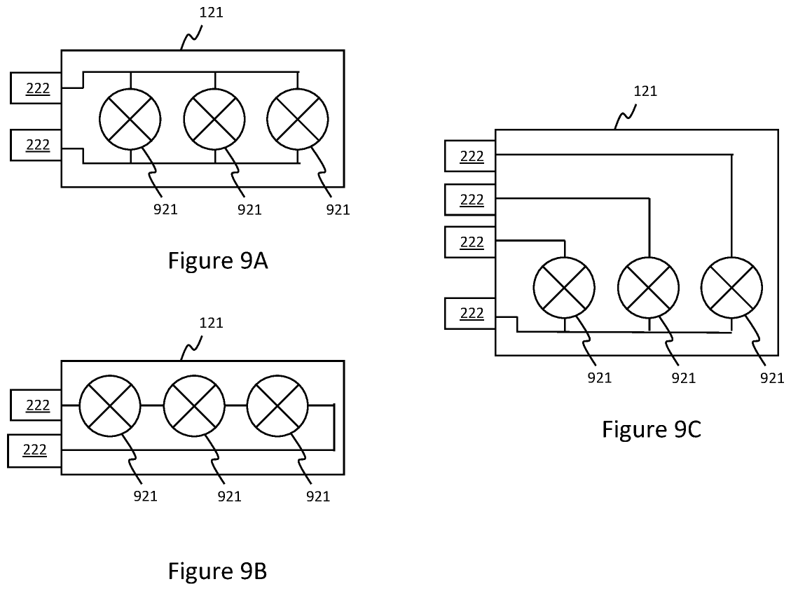

FIGS. 9A-9C show example remote light devices 121 comprising a plurality of illumination elements 921 (e.g. LEDs or light bulbs). The individual illumination elements 921 may be connected in parallel, as is shown in FIG. 9A, connected in series, as is shown in FIG. 9B, and/or connected individually with a common return, as is shown in FIG. 9C.

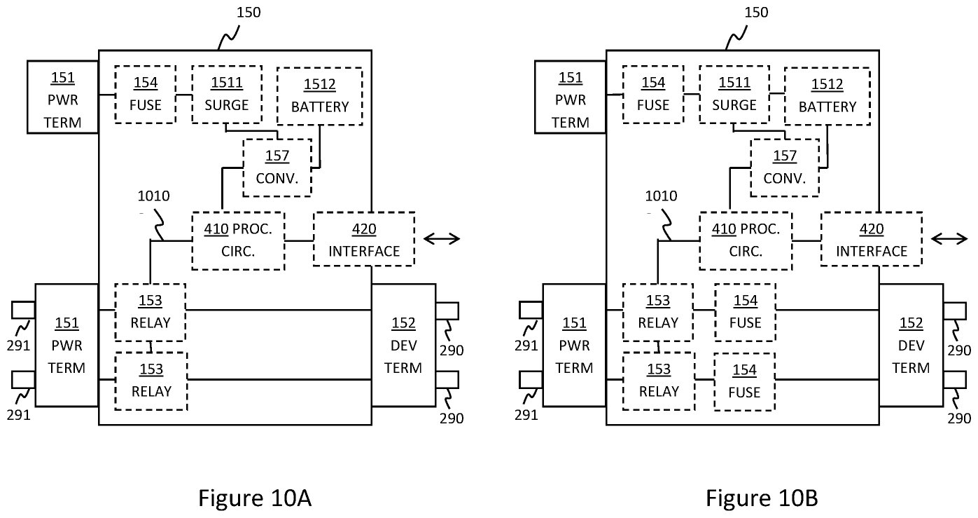

FIGS. 10A and 10B show example control units 150 with major internal components, suitable for the example configuration from FIG. 2A. The power terminal 151 connects power to the processing circuitry 410, interface 420 for communications, and drive signals 1010 for the relays 153. The power is regulated by a power converter 157 to a suitable voltage level. The device is protected by a fuse 154 and surge protection circuit 1511. The processing circuitry 410, interface 420 and drive signals 1010 are further powered by a backup battery 1512 in case the main power 111 is disconnected. The backup battery 1512 also comprises a management system arranged to manage charge levels and to protect the battery from over- or undervoltage conditions. Each branch 290 is powered from the remote power source 210 via the transformer 257 and via respective power terminal branches 291 on the power terminal 151, as illustrated in FIG. 2A.

FIG. 10A shows a single fuse next to the surge protection circuit 1511. In this specific case, the power rating of remote power source 210 is less than the power rating of the branches 290. Thus, the device relies on the protection circuitry ow the power source to prevent damage from overload conditions.

FIG. 10B shows additional fuses connected between the relays and the device terminal 152. In this specific case, the power rating of remote power source 210 is larger than the power rating of the branches 290. Thus, the device relies on its internal fuse to prevent damage from overload conditions.

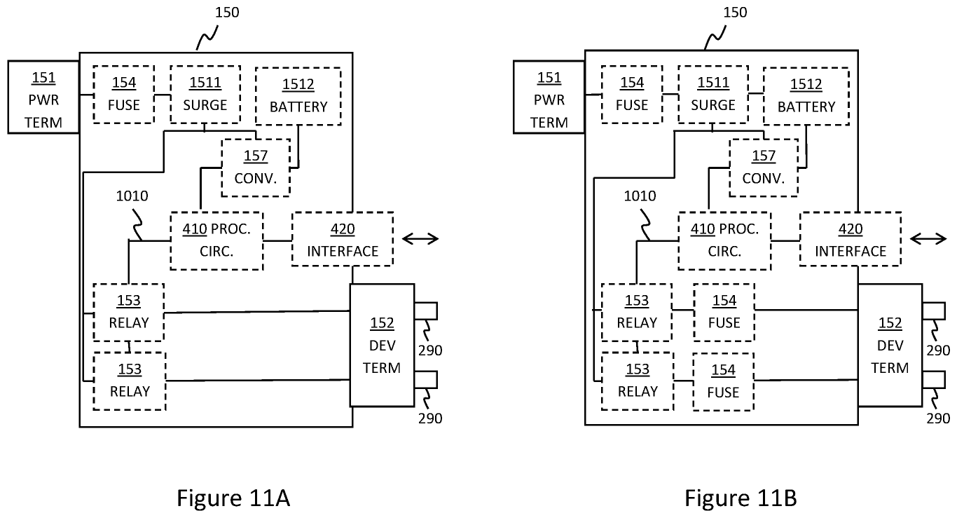

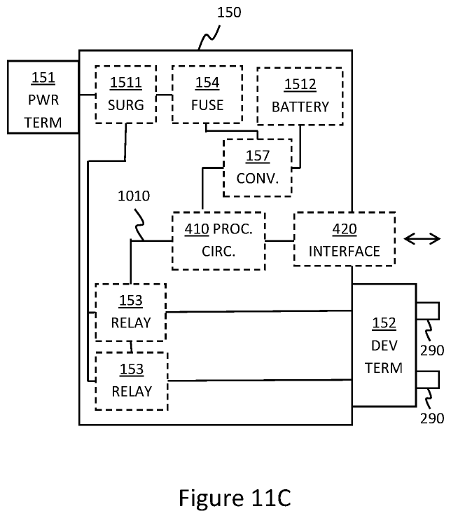

FIGS. 11A-11C show example control units 150 with major internal components, suitable for the example configuration from FIG. 2B. The internal components are similar to the example control units of FIGS. 10A-10B. A difference is that the control units of FIGS. 11A-11C are lacking a dedicated power terminal 151 for powering the branches 290.

FIG. 11A shows a single fuse next to the surge protection circuit 1511. In this specific case, the power rating of remote power source 210 is less than the power rating of the branches 290.

FIG. 11B shows additional fuses connected between the relays and the device terminal 152. In this specific case, the power rating of remote power source 210 is larger than the power rating of the branches 290.

FIG. 11C is similar to FIG. 11A. A difference is that power to the relays is routed via the fuse 154 in FIG. 11A and that it is not routed via the fuse 154 in FIG. 110.

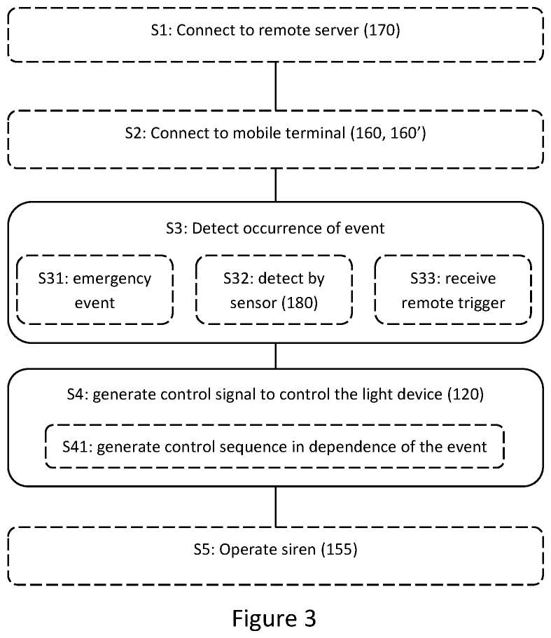

FIG. 3 is a flow chart illustrating methods which summarize the discussions above. There is illustrated a method for communicating information 101 to a person 102 in a local area 103 associated with a construction site. The method comprises detecting S3 the occurrence of an event. The event may be an emergency event S31. The event may either be detected S32 by some sensor system 180 or manually detected, whereupon a remote trigger signal S33 is received, possibly from the mobile terminal 160, 160′.

The method also comprises S4 generating a control signal to control the remote light device 121, i.e. controlling the remote light device 121 according to the principles discussed above, though controlling the electrical connection 159 and/or by controlling the light parameter. It is noted that the method may operate also based on other types of noticeable devices than remote light devices that may rely on being noticeable by the person 102 through hearing and/or feeling. The control may also comprise generating S41 a particular control sequence in dependence of the detected event.

The method may comprise reinforcing the information dissemination by operating S5 a siren 158 to provide an audible alarm signal or attention signal in addition to the operation of the control unit 150.

During set-up and initialization, the method may comprise connecting S1 the system to a remote server 170 and/or establishing a connection S2 to a mobile device 160, 160′.

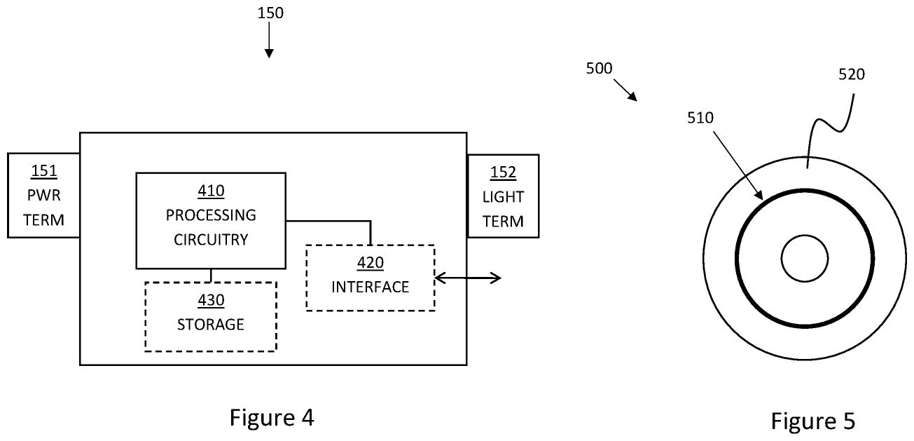

FIG. 4 schematically illustrates, in terms of a number of functional units, the components of the control unit 150 according to an embodiment of the discussions herein. The control unit 150 comprises processing circuitry 410 arranged to generate the control signal in response to an event. The processing circuitry 410 is provided using any combination of one or more of a suitable central processing unit CPU, multiprocessor, microcontroller, digital signal processor DSP, etc., capable of executing software instructions stored in a computer program product, e.g. in the form of a storage medium 430. The processing circuitry 410 may further be provided as at least one application specific integrated circuit ASIC, or field programmable gate array FPGA.

Particularly, the processing circuitry 410 is configured to cause the control unit 150 to perform a set of operations, or steps, such as the methods discussed in connection to FIG. 3. For example, the storage medium 430 may store the set of operations, and the processing circuitry 410 may be configured to retrieve the set of operations from the storage medium 430 to cause the control unit 150 to perform the set of operations. The set of operations may be provided as a set of executable instructions. Thus, the processing circuitry 410 is thereby arranged to execute methods as herein disclosed.

The storage medium 430 may also comprise persistent storage, which, for example, can be any single one or combination of magnetic memory, optical memory, solid state memory or even remotely mounted memory.

The control unit 150 may further comprise an interface 420 for communications with at least one external device, such as the mobile terminal 160′, and the remote server 170. As such, the interface 420 may comprise one or more transmitters and receivers, comprising analogue and digital components and a suitable number of ports for wireline or wireless communication.

The processing circuitry 410 controls the general operation of the control unit 150 e.g. by sending data and control signals to the interface 420, the device terminal 152, and the storage medium 430, by receiving data and reports from the interface 420, and by retrieving data and instructions from the storage medium 430. Other components, as well as the related functionality, of the control node are omitted in order not to obscure the concepts presented herein.

FIG. 5 schematically illustrates a computer program product 500, comprising a set of operations 510 executable by the control unit 150. The set of operations 510 may be loaded into the storage medium 430 in the control unit 150. The set of operations may correspond to the methods discussed above in connection to FIG. 3.

In the example of FIG. 5, the computer program product 500 is illustrated as an optical disc, such as a CD (compact disc) or a DVD (digital versatile disc) or a Blu-Ray disc. The computer program product could also be embodied as a memory, such as a random-access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program is here schematically shown as a track on the depicted optical disk, the computer program can be stored in any way which is suitable for the computer program product.

There was also disclosed herein a computer program for a mobile terminal 160, 160′. The program is arranged to establish a connection, either directly to the control unit 150 or indirectly via some remote server 170. The computer program is configured to generate a signal and transmit the signal to the control unit 150.

According to some aspects, the computer program for the mobile terminal 160, 160′ is further arranged to receive a status information signal from the control unit 150. This status information signal may indicate an alarm event or just a status of the control unit 150, i.e., that the control unit 150 is fully operational, or that the control unit 150 has detected some system fault and needs maintenance or service.

Example systems for communicating information to a person in a local area will now be discussed which make use of more general devices that are turned off from an initially active state in order to communicate information to the person in the local area discussed above. These example systems comprise a power source arranged to power a device arranged noticeable by the person. The systems also comprise a relay arranged in-between the power source and the device to temporarily disconnect the device from the power source based on a control signal from an initially active state, thereby communicating information to the person. The example systems furthermore comprise a control unit arranged to generate the control signal in response to an event.

By using a device arranged noticeable, such as a light source, a person is able to see, feel or hear that there is an alarm signal, since the device arranged noticeable is temporarily disconnected by the system, i.e., turned off from a permanent or semi-permanent state. Other noticeable devices may include, e.g., fans and certain types of machinery, such as machinery generating noticeable noise and vibration. Thus, the device is used actively as long as the control signal is generated, i.e., the fan turns to move air, the work light source provides working light which illuminates the local area, and so on. When the control signal is generated, the device is turned off from this active state. When the device stops operating and enters into an inactive state, the person notices this and the information is thereby communicated.

The system does not rely on a permanent information dissemination system installation, but instead makes use of a power source, which can be a temporary power grid at a construction site or the like. Such temporary power sources are often available even if no permanent infrastructure for communication or warning has been installed. In fact, one of the first systems in place at a construction site is often a temporary power grid or cable to power tools and construction machinery.

It is an advantage that the device is only temporarily turned off by the relay, since the device may be necessary for the evacuation. For instance, turning off lights entirely may complicate an evacuation. It is appreciated that this turning off of the device is different from a blinking operation that is initiated from an inactive state, i.e., a siren or warning light which is silent as long as there is no control signal and then turned on in response to the control signal.

According to aspects, the information is an alarm signal and the event is an emergency event associated with the local area. Although the disclosed system can be used to disseminate various other types of messages, it is particularly suitable for use with emergency evacuation signals and other warning signals.

According to aspects, the control unit is arranged to sequentially connect and disconnect the device to and from the power source according to a pre-determined time sequence in dependence of a type of the event, thereby communicating the information to the person. Blinking lights or some other device turning on and off according to some time sequence is noticeable in many local areas, and therefore an effective warning system even if noise levels are high. The blinking pattern can also be adjusted to communicate various different messages, for instance, a rapid blinking can be an alarm signal prompting immediate evacuation, while a slow blinking can be a signal prompting personnel to seek information at some gathering point. Thus, a versatile information dissemination system is provided, which is an advantage.

According to aspects, the system comprises a mobile device arranged to remotely trigger generation of the control signal. The mobile device may, e.g., be a cellular device connected to the system via a cellular system, a local area network (LAN) device connected to the system via a local area network, or some other radio transceiver such as a walkie-talkie or the like which can be directly connected to the control unit via wireless link.

According to aspects, the control unit comprises a siren, buzzer, or other sound generating device. Thus, the temporary disconnecting of the device can be complemented by some more traditional warning system, such as the siren. This way an alarm signal becomes even more noticeable by personnel in the local area. The siren can be driven by the power source, since the power source can be connected to the siren without being affected by the relay operation.

According to aspects, the control unit and the relay are integrated into a single unit. By integrating control unit and relay, a single unit is provided which can be made more resilient to mechanical impact and damage from, e.g., water or the like, which is an advantage. Also, a single unit is more easily installed and managed.

According to aspects, the system also comprises one or more sensor devices connected to the control unit and arranged to detect occurrence of the event. Such sensors may, e.g., comprise gas leak sensors or fire detectors. This way a more complete warning system can be obtained based on a power grid such as a temporary power grid at a construction site.

FIG. 6 shows another example system 600 for communicating information 101 to a person 102 in a local area 103.

The local area may, e.g., be a construction site or some other local area where no permanent evacuation alarm system has been installed. The communicated information 101 may be an alarm signal indicating occurrence of an emergency event associated with the local area 103. However, the system can also be used for more general information dissemination.

The disclosed system is particularly suitable for use at construction sites and the like which are often equipped with temporary power sources, such as temporary power grid systems or power cables, but which rarely comprise permanent evacuation systems.

The system comprises a power source 110 arranged to power a device 120 arranged noticeable by the person 102. This means that the person can see, hear or feel that the device is in operation, i.e., that it is powered by the power source. A preferred device 120 is a light source 121 which can be seen by personnel occupying the local area. However, it is noted that the system may operate also based on other types of noticeable devices.

As discussed above, the device arranged noticeable is active in a default state, i.e., the light source can for instance be a 40 W-200 W light source used as work light to illuminate the local area in absence of a control signal indicating the onset of some event which is to be communicated to the person 102. A fan is normally active in absence of the control signal, and machinery, such as drilling equipment or the like, is normally active and is then turned off in response to the control signal.

The system 600 also comprises a relay 153 arranged in-between the power source 110 and the device 120 to temporarily disconnect the device from the power source based on a control signal 610. This way, when the relay 153 acts to disconnect the device 120 from the power source 110, the person 102 notices the event and is thereby made aware that something is going on. Thus, by temporarily disconnecting the device from the power source based on a control signal 610, information is communicated to the person 102.

The system also comprises a control unit 150 arranged to generate the control signal 610 in response to an event. The control unit may operate the relay to sequentially connect and disconnect the device 120 to and from the power source 110 according to a pre-determined time sequence in dependence of a type of the event, thereby communicating the information 101 to the person 102. Note however that this sequence always begins by the control unit turning the device off, not on as in a blinking warning light which is normally inactive. The pre-determined time sequence may be just normal blinking, assuming the device is a light source, at some rate. However, more advanced signals may be communicated by varying the blinking pattern. For instance, rapid blinking may indicate some type of event, like an emergency requiring immediate evacuation, while more slow blinking may indicate an emergency requiring caution but not immediate evacuation.

According to some aspects, the system comprises one or more mobile devices 160, 160′ arranged to remotely trigger generation of the control signal 610. The mobile device may be a cellular device connected to the system 600 via a remote server 170 or via some network. The mobile device 160′ may also be a radio device such as an intercom device configured to directly communicate with the control device. The mobile device 160′ may also comprise a wireless local area network (LAN) transceiver, such as a Wi-Fi transceiver.

According to some aspects, the mobile device may be a wireless transceiver comprised in an alarm button or the like.

It is noted that the system 600 also comprises an optional siren 158 or other audio-based alarm system. This is a complementary warning system which acts to reinforce the information signal communicated to the person 102 by means of the relay 153 and device 120.

The control unit 150 and the relay 153 may be integrated into a single unit 659, or they can be separated into two or more units. However, an integrated device brings the additional benefits of being easier to install, more convenient to transport and to handle, and it can also be made more resilient to, e.g., water, since there will be fewer external interfaces.

According to aspects, the system 600 comprises one or more sensor devices 180 connected to the control unit 150 and arranged to detect occurrence of the event. These sensor devices are optional, but may comprise, e.g., gas sensors, fire detection devices, or the like.

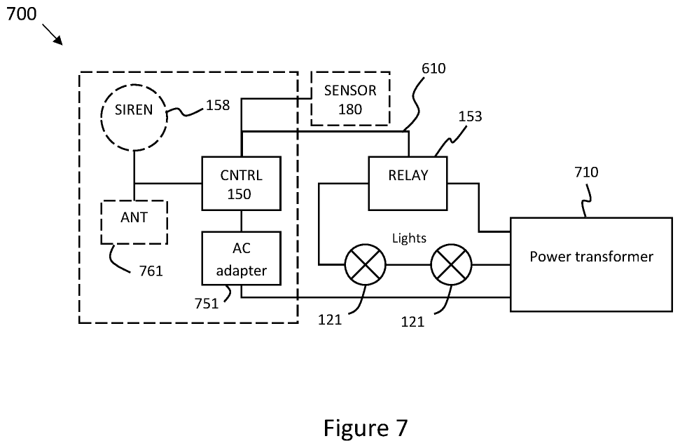

FIG. 7 shows yet another example warning system 700 according to the discussions above. A power transformer 710 here constitutes the power source 110. The power transformer is connected to one or more light sources 121 via the relay 153, i.e., the device is here exemplified by light sources. These light sources are preferably working light sources such as those normally present at a construction site to illuminate the site, i.e., to provide working light. Such light sources normally have a light intensity corresponding to a light source of about 40W-200W or more. The lights can be temporarily turned off by operating the relay 153 but are normally active in absence of the control signal. The relay 153 is arranged to be controlled by a control unit 150. Here, the control unit 150 is also powered by the power transformer 710 via an alternating current (AC) adapter 751. The control unit 150 is also connected to an optional siren 158 and also to an optional antenna 761 for communicating with, e.g., a mobile device 160, 160′ or a wireless emergency button. One or more optional sensors 180 can be connected to the control unit in order to enable automatic alarm generation and the like. The sensors may comprise fire detectors, gas leakage sensors, carbon monoxide detection sensors, or the like.

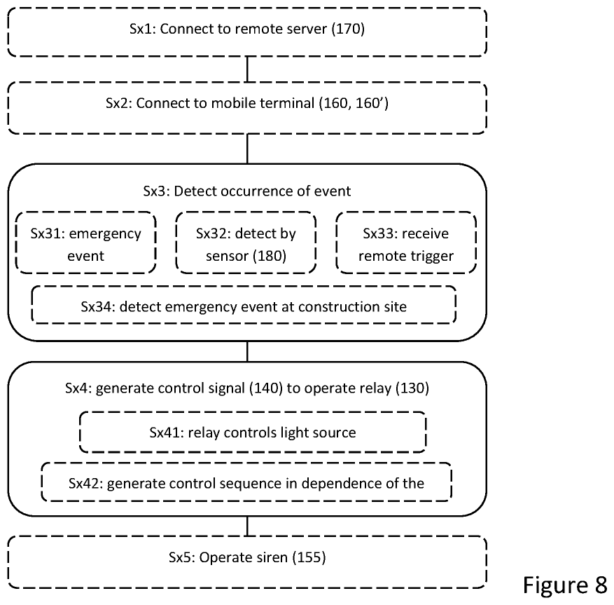

FIG. 8 is a flow chart illustrating methods which summarize at least part of the discussions above. There is illustrated a method for communicating information 101 to a person 102 in a local area 103. The method comprises detecting (Sx3) the occurrence of an event. The event may be an emergency event Sx31. The event may either be detected Sx32 by some sensor system 180 or manually detected, whereupon a remote trigger signal Sx33 is received, possibly from the mobile terminal 160, 160′. As noted above, the emergency event may be an emergency event at a construction site Sx34.

The method also comprises generating a control signal to operate a relay device according to the principles discussed above. For instance, the relay may be configured to control Sx41 a light source, such as the light source 121 exemplified in FIG. 7. The control may also comprise generating Sx42 a particular control sequence in dependence of the detected event.

The method may comprise reinforcing the information dissemination by operating Sx5 a siren 158 to provide an audible alarm signal or attention signal in addition to the operation of the relay.

During set-up and initialization, the method may comprise connecting the system to a remote server 170 and/or establishing a connection to a mobile device 160, 160′.

1. A system for communicating information to a person in a local area, the system comprising
a device arranged noticeable by the person,
a power source arranged to power the device,
a relay arranged in-between the power source and the device, and
a control unit arranged to generate a control signal in response to an event,
wherein the relay is arranged to connect the device to the power source in absence of the control signal, and to temporarily disconnect the device from the power source in response to the control signal generated by the control unit, thereby communicating the information to the person.

2. The system according to claim 1, wherein the device is any of a light source, a fan, or construction machinery.

3. The system according to claim 1, wherein the information is an alarm signal and wherein the event is an emergency event associated with the local area.

4. The system according to claim 1, wherein the local area is a construction site and wherein the power source is connected to a temporary power infrastructure deployed at the construction site.

5. The system according to claim 1, wherein the control unit is arranged to sequentially connect and disconnect the device to and from the power source, after initially disconnecting the device from the power source in response to the control signal, according to a pre-determined time sequence in dependence of a type of the event, thereby communicating the information to the person.

6. The system according to claim 1, comprising a mobile device arranged to remotely trigger generation of the control signal.

7. The system according to claim 1, wherein the control unit comprises a siren.

8. The system according to claim 1, wherein the control unit and the relay are integrated into a single unit.

9. The system according to claim 1, comprising one or more sensor devices connected to the control unit and arranged to detect occurrence of the event.

10. The system according to claim 1, wherein the power source is a remote power source and wherein the control unit comprises a power terminal arranged to connect the control unit to the remote power source via a first electrical wire.

11. The system according to claim 1, wherein the device is a remote light device and wherein the control unit comprises a device terminal arranged to connect the control unit to the remote light device via a second electrical wire.

12.-27. (canceled)

28. The system according to claim 2, wherein the information is an alarm signal and wherein the event is an emergency event associated with the local area.

29. The system according to claim 2, wherein the local area is a construction site and wherein the power source is connected to a temporary power infrastructure deployed at the construction site.

30. The system according to claim 3, wherein the local area is a construction site and wherein the power source is connected to a temporary power infrastructure deployed at the construction site.

31. The system according to claim 2, wherein the control unit is arranged to sequentially connect and disconnect the device to and from the power source, after initially disconnecting the device from the power source in response to the control signal, according to a pre-determined time sequence in dependence of a type of the event, thereby communicating the information to the person.

32. The system according to claim 3, wherein the control unit is arranged to sequentially connect and disconnect the device to and from the power source, after initially disconnecting the device from the power source in response to the control signal, according to a pre-determined time sequence in dependence of a type of the event, thereby communicating the information to the person.

33. The system according to claim 4, wherein the control unit is arranged to sequentially connect and disconnect the device to and from the power source, after initially disconnecting the device from the power source in response to the control signal, according to a pre-determined time sequence in dependence of a type of the event, thereby communicating the information to the person.

34. The system according to claim 2, comprising a mobile device arranged to remotely trigger generation of the control signal.

35. The system according to claim 3, comprising a mobile device arranged to remotely trigger generation of the control signal.

36. The system according to claim 4, comprising a mobile device arranged to remotely trigger generation of the control signal.
